(19) United States
(12) Patent Application Publication
(10) Pub. No.: US 2021/0015141 A1
(43) Pub. Date: Jan. 21, 2021

(54) ROASTING DRUM AND MANUFACTURING METHOD THEREOF

(71) Applicant: Grand Mate Co., Ltd., Taichung City (TW)

(72) Inventors: CHUNG-CHIN HUANG, Taichung City (TW); Chin-Ying Huang, Taichung City (TW); Hsin-Ming Huang, Taichung City (TW); Hsing-Hsiung Huang, Taichung City (TW); Yen-Jen Yeh, Taichung City (TW); Kuan-Chou Lin, Taichung City (TW); Shao-Feng Huang, Taichung City (TW)

(73) Assignee: Grand Mate Co., Ltd., Taichung City (TW)

(21) Appl. No.: 16/516,069

(22) Filed: Jul. 18, 2019

(51) Int. Cl. A23N 12/10; B21D 53/06

(52) U.S. Cl. CPC A23N 12/10; B21D 53/06

(57) ABSTRACT

A roasting drum and a manufacturing method thereof including a drum body and at least one agitator blade. The drum body includes a drum wall which provides with at least one fixing hole, the at least one fixing hole passing through an inner surface and an outer surface of the drum wall. The at least one agitator blade is disposed in the drum body and is provided with at least one fixing convex part which passes through the at least one fixing hole. The agitator blade can be positioned in the drum body and is not easily displaced when assembling.

### BACKGROUND OF THE INVENTION

### Technical Field

The present invention is related to beans roasting, and more particularly to a roasting drum and a manufacturing method thereof.

### Description of Related Art

Some of bean foods need to be roasted so they can easily show their flavor. Take coffee beans as an example, caffeine has a refreshing effect and gives off a unique aroma, which is loved by many people, so it has become a popular drink in society. Green coffee beans need to be roasted in a coffee bean roaster to have coffee beans ripened. The roasting process is to put coffee beans in a rotating drum under which a heating device is disposed to heat the drum so that the coffee beans are roasted in the drum. Since the heating device is located under the drum, the drum wall is heated directly, and the coffee beans contact the drum wall directly, which causes the coffee beans easily to get burnt black or scorched and consequently affects the taste of the coffee beverage.

To have coffee beans heated uniformly in the process of roasting, inside a drum of a conventional coffee bean roaster is usually provided with agitator blades. During the rotation of the drum, coffee beans are agitated by the agitator blades to keep them from contacting the drum wall for too long to be burnt black or scorched, which shows the importance of the agitator blades in a coffee bean roaster. However, the conventional method of disposing agitator blades in a drum is to place agitator blades in the drum first and then weld the agitator blades onto the drum. Due to the confined space of the drum, the agitator blades are not easy to fix and tend to displace in the welding process, resulting in the difficulty of precise welding between the drum and the agitator blades. Even if the agitator blades are successfully welded onto the drum, the welding position of the agitator blades may be not the same as the predetermined position and needs to be welded again after removing the weld, which causes inconvenience in installation and time consuming.

### BRIEF SUMMARY OF THE INVENTION

In view of the above, a purpose of the present invention is to provide a roasting drum and a manufacturing method thereof to have agitator blades precisely positioned in the drum.

The present invention provides a roasting drum including a drum body and at least one agitator blade. The drum body includes a drum wall which provides with at least one fixing hole, the at least one fixing hole passing through an inner surface and an outer surface of the drum wall. The at least one agitator blade is disposed in the drum body and is provided with at least one fixing convex part which passes through the at least one fixing hole.

The present invention provides a manufacturing method of a roasting drum, comprising the steps of:

providing a drum body which includes a drum wall;

forming at least one fixing hole that passes through an inner surface and an outer surface of the drum wall of the drum body;

providing at least one agitator blade which has at least one fixing convex part;

putting the at least one agitator blade in the drum body and disposing the at least one fixing convex part of the at least one agitator blade into the at least one fixing hole; and

fixing the at least one agitator blade on the drum wall of the drum body.

An advantage of the present invention is to have the agitator blades not easily displaced in the drum body by disposing the fixing convex parts of the agitator blades into the fixing hole and further fix the agitator blades onto the drum wall of the drum body so that the agitator blades can be precisely fixed at the predetermined positions.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a perspective view of a roasting drum of a first embodiment according to the present invention;

FIG. 2 is a flow chart of a manufacturing method of the roasting drum of the first embodiment;

FIG. 3 is a schematic view showing that a pipe is cut to obtain a drum body;

FIG. 4 is a perspective view of the drum body of the roasting drum of the first embodiment;

FIG. 5 is an exploded perspective view of the drum body and one agitator blade of the first embodiment;

FIG. 6 is a schematic view showing that the agitator blade is welded to the drum body;

FIG. 7 is a partial exploded perspective view of the roasting drum of the first embodiment;

FIG. 8 is a partial schematic view of the roasting drum of a second embodiment according to the present invention;

FIG. 9 is a schematic view showing that a part of the drum wall of the second embodiment is located in the locking slot; and

FIG. 10 is a partial schematic view of a roasting drum of a third embodiment according to the present invention.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification.

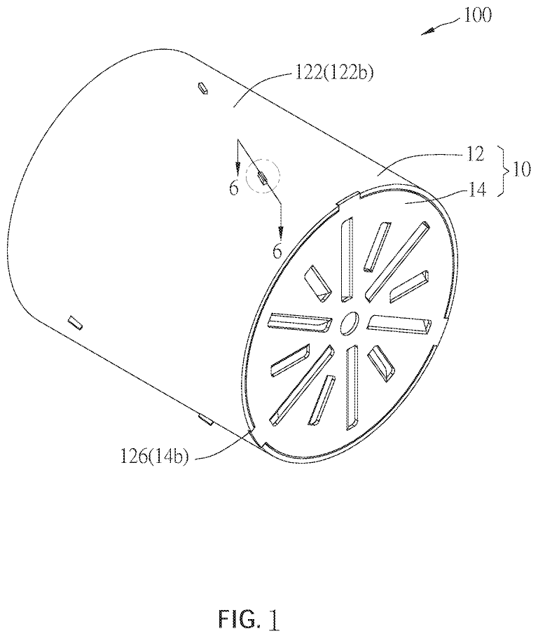

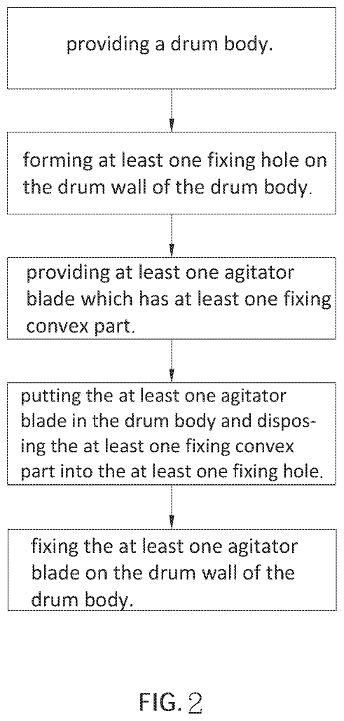

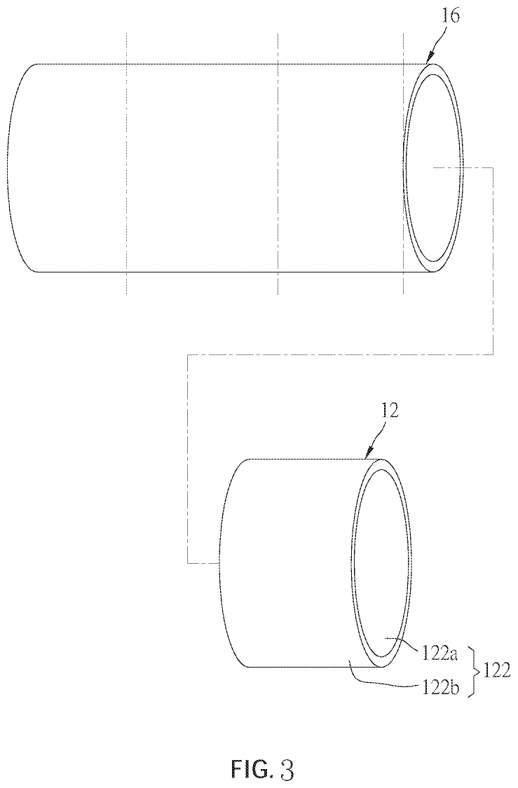

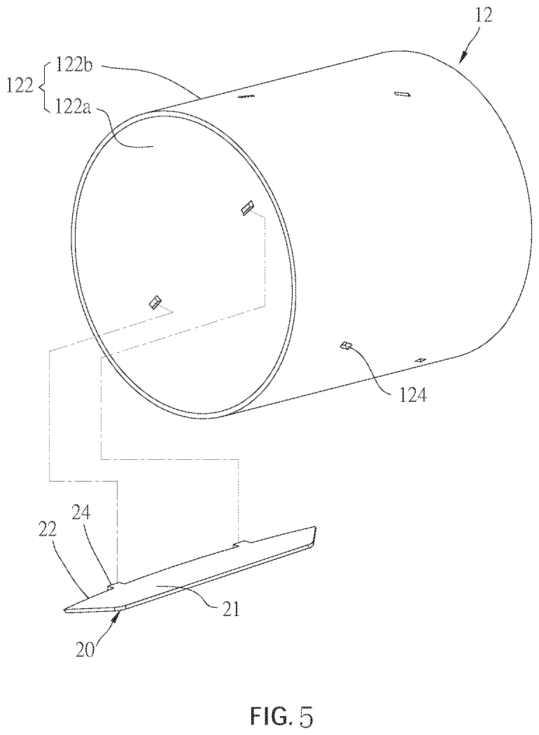

As illustrated in FIG. 1, a roasting drum 100 of a first embodiment according to the present invention comprises a drum 10 and at least one agitator blade (shown in FIG. 5). The drum 10 includes a drum body 12 and an end plate 14. FIG. 2 is a flow chart of a manufacturing method of the roasting drum 100, and the structure and the manufacturing procedure of the roasting drum 100 will be described later with reference to FIG. 3 to FIG. 7.

As shown in FIG. 3, the drum body 12 is segmented by a predetermined length out of a pipe 16, and the drum body 12 obtained after cutting is a hollow cylindrical shape. In the current embodiment, the pipe 16 is made of a metal material, such as iron or stainless steel. An inner diameter of the pipe 16 is 3-6 inches, and, in the current embodiment, the inner diameter of the pipe 16 is 3.5 inches. The drum body 12 includes a drum wall 122 having an inner surface 122a and an outer surface 122b.

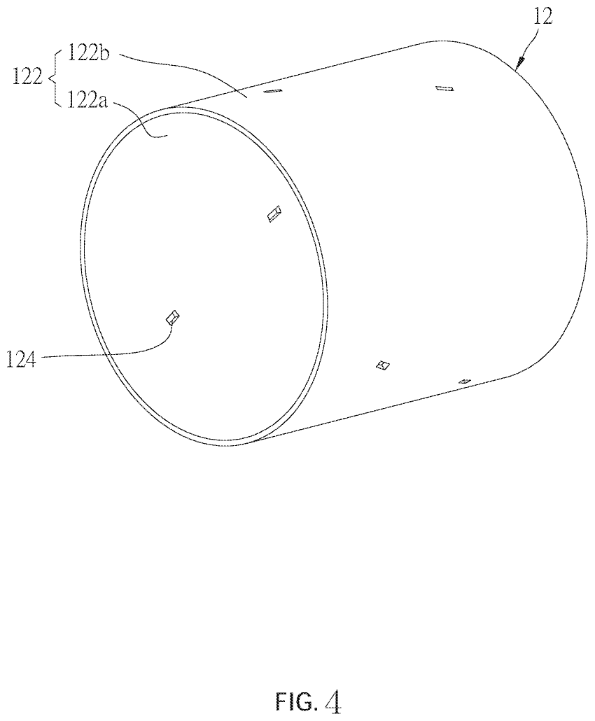

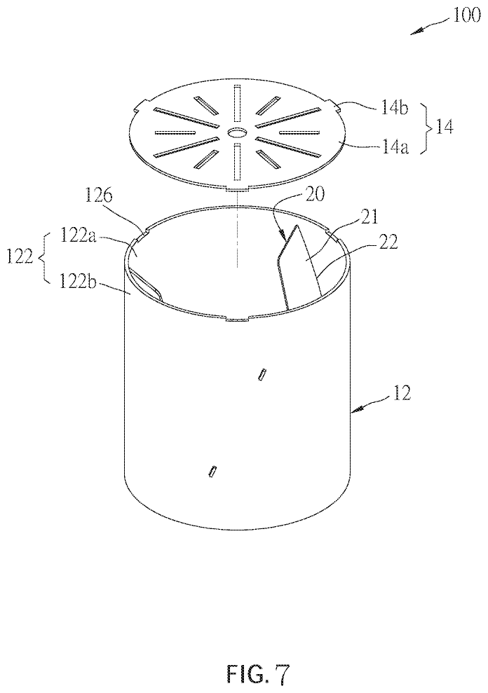

As illustrated in FIG. 4, at least one fixing hole 124 which penetrates the inner surface 122a and the outer surface 122b of the drum body 12 is processed in at least one predetermined position of the drum body 12. In the current embodiment, the at least one fixing hole 124 includes six fixing holes and each of the fixing holes 124 is elongated. The six fixing holes 124 can be divided into three groups. In the current embodiment, the drum body 12 further has a first joint part which is at least one recess 126 as an example, and more specifically, the recess 126 is formed out of one end of the drum body 12 (shown in FIG. 7). The at least one recess 126 is concavely formed out of an end edge of the drum body 12 and includes three recesses 126.

As shown in FIG. 5, at least one agitator blade 20 is provided. The agitator blade 20 includes a sheet-like blade body 21 and at least one fixing convex part 24, wherein the blade body 21 has a side edge 22 and the fixing convex part 24 is convexly formed out of the side edge 22. In the current embodiment, the at least one agitator blade 20 includes three agitator blades 20 and the fixing convex part 24 of each agitator blade 20 includes two fixing convex parts. Preferably, a height of the fixing convex part 24 protruding from the side edge 22 is greater than a thickness of the drum wall 122 of the drum body 12.

When assembling, place the drum body 12 on a working platform first, and then put the agitator blades 20 into the drum body 12 one by one. Each of the agitator blades 20 is assembled in the same manner Take one agitator blade 20 as an example in the following description.

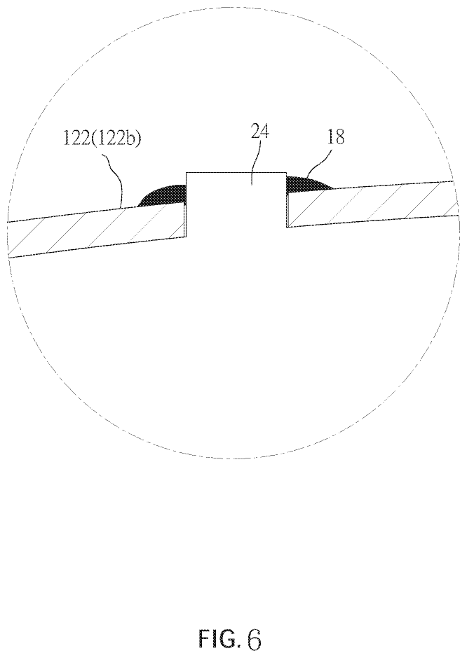

Target the fixing convex parts 24 of the agitator blade 20 at one group of the fixing holes 124 to pass each of the fixing convex parts 24 through the corresponding one fixing hole 124. The fixing convex parts 24 are exposed on the outer surface 122b of the drum wall 122. As shown in FIG. 6, the joint between each of the fixing convex parts 24 and the corresponding one fixing hole 124 is in a tight-fitting state so that the position of the agitator blade 20 is not offset by tumbling. In practice, it is not limited to the tight-fitting state as long as the fixing convex parts 24 can pass through the fixing holes 124.

Next, fix the agitator blades 20 to the drum wall 122 of the drum body to have the agitator blades 20 disposed at predetermined positions. In the current embodiment 12, the fixing convex parts 24 and the outer surface 122b of the drum body 12 are fixed to each other by welding from an outside of the drum body 12, wherein solder 18 connects the fixing convex parts 24 and the outer surface 122b of the drum wall. For a small-sized drum body 12 (an inner diameter thereof can be 3 to 6 inches), it is preferably being welded externally, but if the inner diameter of the drum body 12 is large enough to have a welding tool working inside the drum body 12, it is not limited to be welded externally. When being welded internally, it is not limited to being welded at the fixing convex parts 24 and may be welded at any proper positions between the blade body 21 and the inner surface 122a of the drum body 12.

As illustrated in FIG. 7, provide the end plate 14 and attach the end plate 14 to one end of the drum body 12, wherein the end has the recess 126. The end plate 14 in the current embodiment includes a circular plate body 14a and at least one second joint part which is at least one protrusion 14b as an example. An outer diameter of the circular plate body 14a is slightly smaller than the inner diameter of the drum body 12. Each of the protrusions 14b protrudes from an outer circumference of the circular plate body 14a in a radial direction. In the current embodiment, the protrusion 14b includes three protrusions 14b.

Further place the other end of the drum body 12 on the working platform to have the recesses 126 facing upward, and place each of the protrusions 14b correspondingly into each of the recesses 126. The outer circumference of the circular plate body 14a is surrounded by the inner surface 122a of the drum body 12. With two sides of each recess 126 for confining corresponding one protrusions 14b, each of the protrusions 14b is stably placed at a predetermined position to prevent the displacement of the end plate 14. Then, attach the end plate 14 and the drum body 12, for example, each recess 126 and a corresponding protrusion 14b are further attached by welding, so that each recess 126 and the corresponding one protrusion 14b are fixed well to each other. The step of attaching the end plate 14 and the drum body 12 can be performed before putting the agitator blades 20 into the drum body 12.

With the above steps, the roasting drum 100 as shown in FIG. 1 can be implemented, and the agitator blades 20 are precisely positioned in the drum body 12.

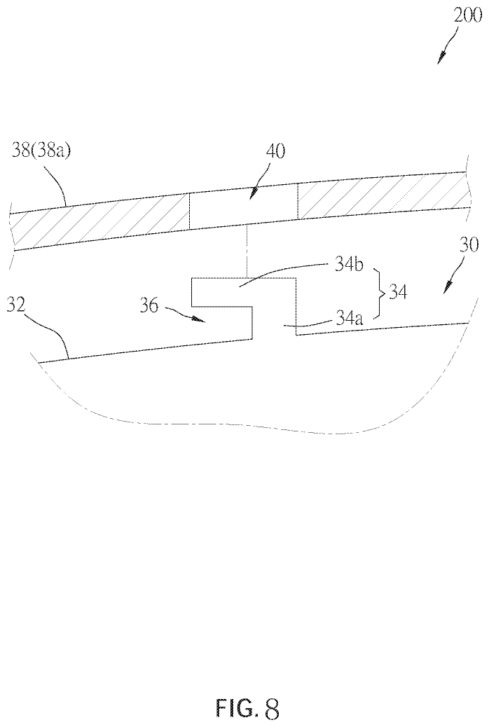

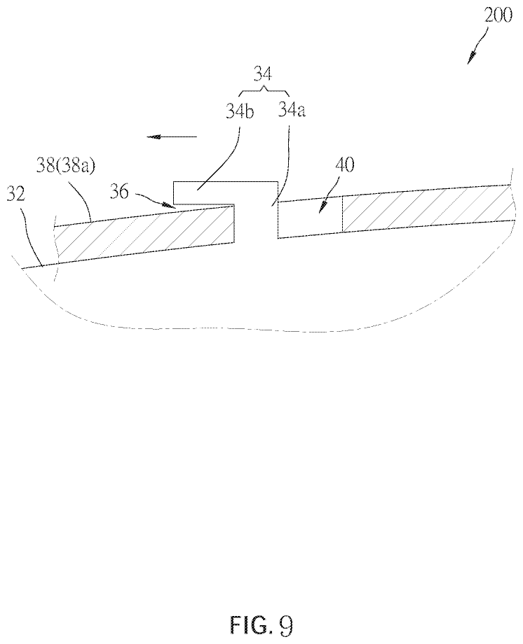

A roasting drum 200 of a second preferred embodiment of the present invention is shown in FIG. 8 and FIG. 9, wherein the roasting drum 200 has a similar structure as the roasting drum 100 of the first preferred embodiment, except that a fixing convex part 34 of an agitator blade 30 in the second embodiment includes a connecting section 34a and an engaging section 34b. The connecting section 34a connects the engaging section 34b and a side edge 32 of the blade body, a width of the connecting section 34a is less than that of the engaging section 34b, and a locking slot 36 is formed between the engaging section 34b and the side edge 32.

When putting the agitator blade 30 in drum body 12, target the fixing convex part 34 of the agitator blade 30 at a fixing hole 40 of the drum wall 38 and place it into the fixing hole 40. Pass the connecting section 34a of the fixing convex part 34 through the fixing hole 40 of the drum wall 38 and the engaging section 34b of the fixing convex part 34 is exposed on an outer surface 38a of the drum wall 38. Move the agitator blade 30 forward to have a part of the drum wall 38 placed in the locking slot 36 so that the engaging section 34b is engaged against the outer surface 38a of the drum wall 38 to have the agitator blade 30 and the drum body 12 is not easily separated. Then, attach the engaging section 34b and the outer surface 38a by welding to have the agitator blade 30 welded fixedly at a predetermined position.

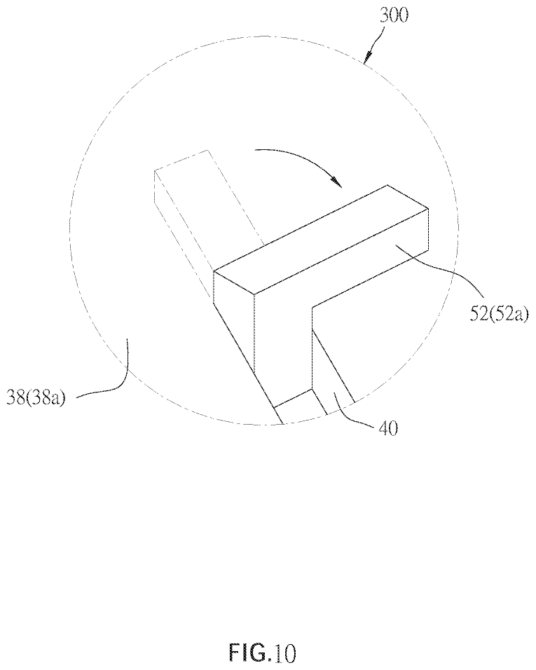

A roasting drum 300 of a third preferred embodiment of the present invention is shown in FIG. 10, wherein the roasting drum 300 has a similar structure as the roasting drum 200 of the second preferred embodiment, except that a protruding part of a fixing convex part 52 protruding from the outer surface 38a of the drum wall 38 is bent at an angle and a bending section 52a is formed. The bending section 52a is engaged against the outer surface 38a of the drum wall 38 to have the agitator blade 30 and the drum body 12 is not easily separated. Then, fix the bending section 52a and the outer surface 38a by welding.

In addition, a drum body attached to an agitator blade is not limited to a drum body having two open ends and may be a drum body having one end with an end plate.

In conclusion, the fixing convex part of the agitator blade and the fixing hole of the drum body of the present invention are attached to each other to be positioned, so that the agitator blade can be disposed at a predetermined position of the drum body, and the position of the agitator blade is not displaced even with the movement of the agitator blade or the drum body during assembly, so as to achieve the effect of precise positioning. The roasting drum of the present invention and the manufacturing method thereof are suitable for making drum bodies of various sizes, in particularly, small-sized drum bodies (inner diameters thereof are 3 to 6 inches) that are not easy for a user's hand or tool to reach into the drum body to hold an agitator blade are more suitable to use the manufacturing method of the roasting drum of the present invention.

The roasting drum of the present invention is not limited to the use of coffee beans, but is also applied to roast any granular food.

It must be pointed out that the embodiments described above are only some embodiments of the present invention. All equivalent structures which employ the concepts disclosed in this specification and the appended claims should fall within the scope of the present invention.

What is claimed is:

1. A roasting drum, comprising:
a drum body including a drum wall which provides with at least one fixing hole, the at least one fixing hole passing through an inner surface and an outer surface of the drum wall; and
at least one agitator blade disposed in the drum body and provided with at least one fixing convex part which passes through the at least one fixing hole.

2. The roasting drum of claim 1, comprising an end plate, wherein an end of the drum body has at least one first joint part; the end plate has at least one second joint part and disposed at the end of the drum body, the at least one second joint part attached to the at least one first joint part.

3. The roasting drum of claim 2, wherein the at least one first joint part is at least one recess which is concavely formed out of an end edge of the drum body, the at least one second joint part is at least one protrusion fitting into the recess.

4. The roasting drum of claim 1, wherein the agitator blade has a side edge, the at least one fixing convex part is convexly formed out of the side edge and includes a connecting section and an engaging section, the connecting section connects the engaging section and the side edge, a locking slot is formed between the engaging section and the side edge, and the drum wall is located in the locking slot.

5. The roasting drum of claim 1, wherein the at least one agitator blade has a side edge, the at least one fixing convex part is convexly formed out of the side edge and includes a connecting section and a bending section, the connecting section connects the bending section and the side edge, and the drum wall is disposed between the bending section and the side edge.

6. A manufacturing method of a roasting drum, comprising the steps of:
providing a drum body including a drum wall;
forming at least one fixing hole that passes through an inner surface and an outer surface of the drum wall of the drum body;
providing at least one agitator blade which has at least one fixing convex part;
putting the at least one agitator blade in the drum body and disposing the at least one fixing convex part of the at least one agitator blade into the at least one fixing hole; and
fixing the at least one agitator blade on the drum wall of the drum body.

7. The manufacturing method of a roasting drum of claim 6, wherein the step of fixing the at least one agitator blade on the drum wall of the drum body is to fix convex part of the at least one agitator blade to the drum wall of the drum body by welding from an outside of the drum body.

8. The manufacturing method of a roasting drum of claim 6, wherein the at least one agitator blade has a side edge, the at least one fixing convex part is convexly formed out of the side edge and includes a connecting section and an engaging section, the connecting section connects the engaging section and the side edge, a locking slot is formed between the engaging section and the side edge; wherein the step of disposing the at least one fixing convex part into the at least one fixing hole includes:
passing the engaging section of the at least one fixing convex part through the at least one fixing hole of the drum body from an inside of the drum body so the engaging section protrudes from the outer surface of the drum wall, and then moving the at least one agitator blade to place a part of the drum wall in the locking slot.

9. The manufacturing method of a roasting drum of claim 6, wherein the at least one agitator blade has a side edge, the at least one fixing convex part is convexly formed out of the side edge; wherein the step of disposing the at least one fixing convex part into the at least one fixing hole includes:
passing the at least one fixing convex part through the at least one fixing hole of the drum body from an inside of the drum body so a part of the at least one fixing convex part protrudes from the outer surface of the drum wall, and then bending the part of the at least one fixing convex part protruding from the outer surface to form a bending section so a part of the drum wall is disposed between the bending section and the side edge.

10. The manufacturing method of a roasting drum of claim 6, wherein the step of providing the drum body includes:
providing a pipe; and
sectionally cutting the pipe by a predetermined length to obtain the drum body.

11. The manufacturing method of a roasting drum of claim 6, comprising providing an end plate and attaching the end plate to one end of the drum body.
